(19) United States
(12) Patent Application Publication
(10) Pub. No.: US 2014/0358769 A1
(43) Pub. Date: Dec. 4, 2014

(54) MERCHANT DATA CORRECTION THROUGH LOCATION AVERAGING

(71) Applicant: MasterCard International Incorporated, Purchase, NY (US)

(72) Inventors: Justin Xavier Howe, Oakdale, NY (US); Randall K. Shuken, Westport, CT (US)

(73) Assignee: MasterCard International Incorporated, Purchase, NY (US)

(21) Appl. No.: 13/903,571

(22) Filed: May 28, 2013

(51) Int. Cl. G06Q 20/38

(52) U.S. Cl. CPC G06Q 20/38
USPC 705/39

(57) ABSTRACT

A computer-implemented method is provided for determining merchant locations. The method includes receiving transaction data and associated location data for transactions between at least one cardholder and at least one merchant, and calculating an average location. The location data associated with each transaction is related to a location of a cardholder of the at least one cardholder making the associated transaction. The calculation includes averaging location data associated with a threshold amount of transactions for one of the merchants. A location of the merchant is determined based on the calculated average location. The method is performed by at least one processing device.

### FIELD OF THE DISCLOSURE

The present disclosure relates to a system and method for determining or correcting merchant location information using aggregation and averaging of location information, and, more particularly, to a system and method that filters unreliable information from aggregated location data associated with a transacting cardholder's cellphone for determining or correcting merchant location information.

### BACKGROUND

Payment networks provide a payment system in which payment cards are used as cash-substitutes for the purpose of enabling payment between members of its network. Such members can include, for example, participating cardholders that were issued a payment card by an issuing bank and merchants. The payment network constantly reviews transaction data associated with transactions between cardholders using payment cards and merchants to detect suspicious or fraudulent activity. Traditionally, payment networks extract address information associated with the merchants from transaction data. However, the information included in the transaction data can be outdated. Furthermore, the location information is provided as an address, e.g., street, city, state, country, zip. However, street names are frequently changed, and many software applications require address information in geolocation coordinates using latitude and longitude. While street address information can be converted to geolocation coordinates using geocoder methods that are known in the art, this requires processing resources and can downgrade accuracy.

Additionally, many transactions using payment cards currently are performed with merchants that are not brick-and-mortar merchants, such as transactions involving e-commerce or recurrent payment. The address information may not reflect the location of the merchant conducting the sale, but may rather be an address of little interest to the payment network, such as an operations facility or a P.O. Box. While transaction data can indicate that a transaction was performed remotely and electronically, the transaction data is often inaccurate in this regard.

There is, therefore, a need in the art for a method and system for obtaining reliable and updated merchant location, such as in geolocation format. Additionally, there is a need to distinguish transaction data that was conducted remotely, such as in e-commerce or recurrent payments.

### SUMMARY

The present disclosure provides a computer-implemented method for determining merchant locations. The method includes receiving transaction data and associated location data for transactions between at least one cardholder and at least one merchant, and calculating an average location. The location data associated with each transaction is related to a location of a cardholder of the at least one cardholder making the associated transaction. The calculation includes averaging location data associated with a threshold amount of transactions for one of the merchants, wherein the location data associated with a transaction is related to a location of a mobile phone of a cardholder of the at least one cardholder making the associated transaction. A location of the merchant is determined based on the calculated average location. The method is performed by at least one processing device.

The present disclosure additionally provides a system for determining merchant locations. The system includes a memory, a computer device, and a module stored in the memory, that when executed by the computer device, performs operations including receiving transaction data and associated location data for transactions between at least one cardholder and at least one merchant and calculating an average location. The location data associated with each transaction is related to a location of a cardholder of the at least one cardholder making the associated transaction. The calculation is performed by averaging location data associated with a threshold amount of transactions for a merchant of the at least one merchant, wherein the location data associated with a transaction is related to a location of a mobile phone of a cardholder of the at least one cardholder making the associated transaction. The operations further include determining a location of the merchant based on the calculated average location.

In addition to the above aspects of the present disclosure, additional aspects, objects, features and advantages will be apparent from the embodiments presented in the following description and in connection with the accompanying drawings.

### BRIEF DESCRIPTION OF THE DRAWINGS

FIG. 1 is a schematic representation of a merchant location determination system in accordance with the present disclosure; and

FIG. 2 is a flow diagram representation of an embodiment of a method of the present disclosure for determining or correcting the location of a merchant.

### DETAILED DESCRIPTION OF THE EMBODIMENTS

The following sections describe exemplary embodiments of the present disclosure. It should be apparent to those skilled in the art that the described embodiments of the present disclosure provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present disclosure as defined herein and equivalents thereto.

The present invention is directed to a method and system for receiving transaction data and location data associated with transactions between cardholders and merchants. The location data associated with a transaction can be provided by a mobile phone service provider that provides service to mobile phone used by the cardholder associated with the transaction. The transaction and location data is aggregated until a threshold amount of transaction and location data is available for a particular merchant. Once sufficiently aggregated, the aggregated location data for the merchant is averaged. The calculated average of the location data is used to filter the aggregated data, e.g., to remove merchants that are not brick-and-mortar merchants and to remove location data that is unreliable. After filtering, the average location calculations are repeated using the filtered aggregated data. This recalculated location represents the location of the merchant. This recalculated location can also be refined using other data that is available. The location data can be geolocation data and/or include geolocation data. The geolocation data can also be converted into a street address using reverse geocoding.

When a cardholder makes purchases with multiple brick-and-mortar merchants, the merchants' locations can be compared. A determination can be made as to whether it was possible to make the transactions based on the times that the transactions were made and the physical distance between the locations. The cardholder can be queried and/or alerted when transaction activity is suspicious based on the determined location of the merchants.

A “payment card,” as used herein, includes a cashless payment device, real or virtual, such as, for example and without limitation, a credit card, a debit card (e.g., signature or PIN enabled), a contactless RFID-enabled device including a smart card Near-Field Communication (NFC) enabled smartphone, an electronic mobile wallet, or the like. The payment card can identify the cardholder as payor and/or an account, or source of funds, from which the payment can be made.

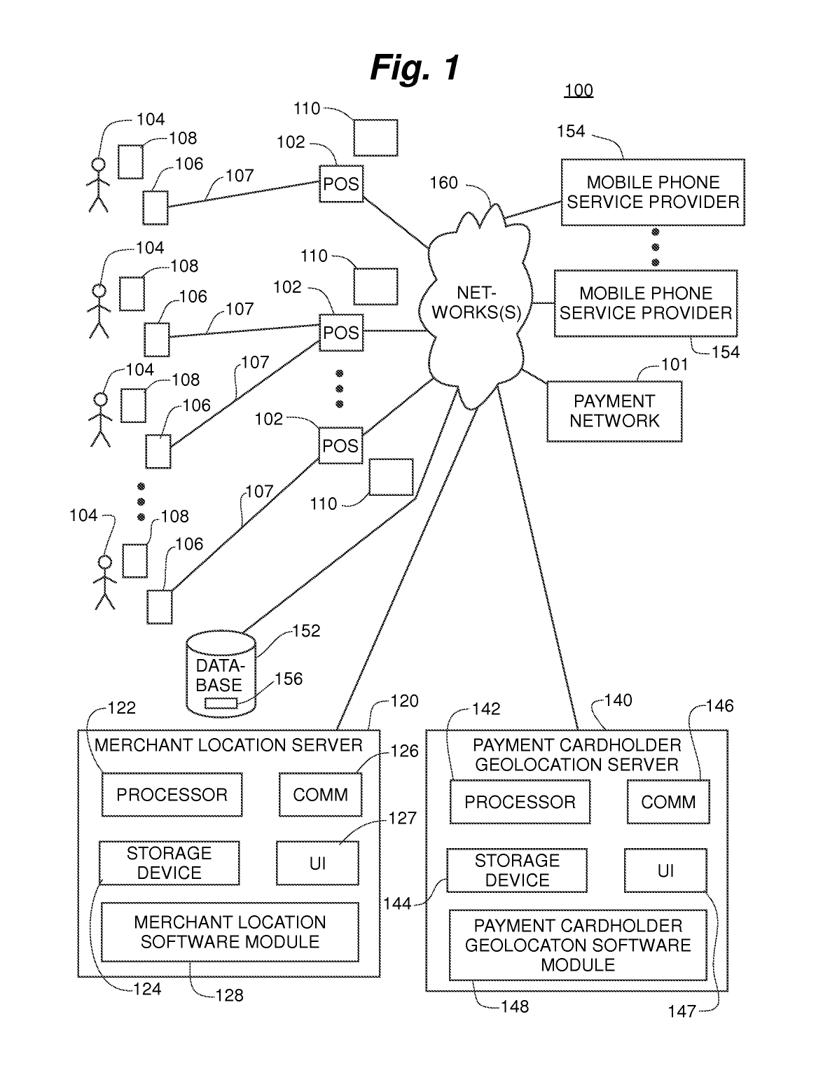

Referring to FIG. 1, in one embodiment, an example merchant location determination system for determining or correcting a merchant location is shown generally as merchant location determination system 100. The merchant location determination system 100 includes a plurality of POS devices 102 that process transactions using a payment card 106 between a payment cardholder 104 and a merchant 110. The payment card 106 and merchant 110 are enrolled with payment network 101, and thus can make a transaction using the payment card 106.

Payment network 101 provides a payment system using payment cards 106 associated with the payment network 101 as cash-substitutes for the purpose of enabling payment between members of its network. Such members can include, for example, participating cardholders 104 and merchants 110. Cardholders 104 are individuals or entities that were issued a payment card 106 by an issuing bank (not shown) that is enrolled with the payment network 101 that the payment card 106 is associated with. Payment network 101 can enroll a variety of merchants 110, merchant banks (not shown), and issuing banks (not shown) to participate in its network.

Merchants 110 can establish a relationship with a merchant bank, thereby allowing the merchant 110 to receive payment for goods and/or services via payment cards 106. The merchant banks and issuing banks can participate with more than one payment network 101. One such payment network 101 is operated by MasterCard International Incorporated, the assignee of the present invention.

A cardholder 104 can present a payment card 106 to a merchant 110 via a POS device 102 operated, controlled, supervised or the like by the merchant 110, thus beginning an authorizing phase of the transaction. The authorizing phase can include validating the payment card 106 or the cardholder's authority to use it, and/or confirming that the cardholder 104 has a sufficient line of credit to cover the proposed payment. The merchant 110 sends an authorization request, e.g., via its POS device 102, to its merchant bank. In turn, the merchant bank communicates with the payment network 101, which responds by communicating with the issuing bank to determine whether the cardholder 104 is authorized to make the transaction in question. An approval or disapproval of the authorization request is thereafter transmitted back to the merchant 110, e.g., via its POS device 102. The merchant 110 thereafter either completes or cancels the transaction based upon the response to the authorization request, which also can be performed using the merchant's POS device 102.

If the approval is granted and the merchant 110 proceeds with the transaction, a clearing phase of the transaction is commenced. During the clearing phase, funds are moved from the cardholder's account held by the issuing bank to the merchant bank. Specifically, the transaction amount is sent from the issuing bank through the network to the merchant bank. This transaction amount, minus certain fees that can be charged, is thereafter deducted from a bank account held in the issuing bank that belongs to the cardholder 104, and deposited within a bank account held in the merchant bank that belongs to the merchant 110.

The cardholder 104 typically carries a mobile phone 108, such as a cellphone or smartphone. The mobile phone 108 can include a Global Positioning Satellite (GPS) device that includes hardware and software for communicating with GPS satellites and determining a location of the mobile phone 108 based on those communications.

For their own purposes or per statutory regulations, mobile phone service providers 154 regularly store geolocation data associated with mobile phones enrolled with their service. The geolocation data can be obtained using GPS data generated by GPS enabled mobile phones or by radiolocation methods. Privacy concerns, and in some cases regulations, may require that such geolocation data be provided by the mobile phone service providers 154 in a manner that guards the cardholder's 104 privacy. Thus, mobile phone service providers 154 may opt or be required to take certain precautions when providing geolocation data to a third party, such as the payment network 101. One such precaution can include aggregating geolocation data with at least a predetermined threshold number of cardholders 104 or transactions. Another precaution can include providing average geolocations for a plurality of mobile phones rather than the geolocation of a particular or identifiable mobile phone.

The POS device 102 is a device that is used for transmitting transaction data related to a transaction using a payment card to one or more transaction parties. When a payment card 106 is presented to the POS device 102, the POS device 102 obtains or receives ID information that identifies the payment card 106, and transmits transaction data related to the transaction to a transaction party that is involved in the transaction, e.g., the merchant's merchant bank. Presentation of the payment card 106 to the POS device 102 is represented by dotted line 107. The type of presentation depends on the type of payment card 106 and POS device 102. For example, with a POS device 102 having a magnetic strip, optical code, or radio frequency scanner, presentation may include scanning the payment card 106 of the appropriate type to obtain the ID information. A manual presentation may include manually entering the ID information into a computer system. The disclosure is not limited to any particular type of presentation.

The POS device 102 transmits transaction data related to the authorizing and/or clearing phases of the transaction. This data can include, for example, payment network identification, the payment card ID, the date and time of the transaction, merchant identification, transaction amount, whether the card number was entered manually or via reading the ID from a magnetic stripe, and/or type of transaction (e.g., transaction with a brick-and-mortar merchant, an e-commerce transaction or a recurring transaction, etc.)

Examples of POS devices include one or more of a computerized cash register, a computer device (e.g., personal computer, handheld computer, smart phone), a payment card reader (e.g., having an optical, magnetic, or radio frequency scanning device that reads ID information from the payment card and/or merchandise to be purchased), a digital scale, and a wired or wireless communication device for communicating with the transaction party. Such communication can be, for example, via a network 160. A POS device can include a telephone via which merchant personnel can communicate transaction data, such as to merchant bank personnel who can then enter the information into a computer.

A merchant location server 120 is provided that includes at least one processor 122, storage device 124, communication device 126, user interface (UI) device 127, and merchant location software module 128. The merchant location server 120 may be integrated with the payment network 101 or operate under the supervision of payment network 101 with the capability to exchange data with payment network 101, e.g., via network 160 using a secure link.

Additionally, a cardholder geolocation server 140 is provided that includes at least one processor 142, storage device 144, communication device 146, user interface (UI) device 147, and cardholder geolocation software module 148. The cardholder geolocation server 140 may be integrated with the payment network 101 or operate under the supervision of payment network 101 with the capability to exchange data with payment network 101, e.g., via network 160 using a secure link.

Processors 122 and 142 can include, for example, a CPU, an application specific integrated circuit (ASIC), and/or microprocessor, or a combination thereof. Processors 122 and 142 can access storage devices 124 and 144, respectively. Storage devices 124 and 144 can include, for example, any combination of computer readable memory to store programmable instructions that are executable by processors 122 and 142, respectively, random access memory (RAM), read only memory (ROM), a storage device including a hard drive, or a portable, removable computer readable medium, such as a compact disk (CD) or a flash memory, or a combination thereof. Storage devices 124 and 144 can be provided at the same physical location as processors 122 and 142, and/or can be provided at a different location that is remote from the location of processors 122 and 142.

Communication devices 126 and 146 include hardware and software configured to provide wired or wireless communication, such as between each of processors 122 and 142 and other processing devices. UI devices 127 and 147 include hardware and software configured to provide for receiving user input. For example, UI devices 127 and 147 can include a keyboard, keypad, mouse, and/or touchscreen. UI devices 127 and 147 further include hardware and software configured to provide for outputting information to a user. For example, UI devices 127 and 147 can generate a graphical user interface (GUI) configured to be displayed on a display device, printer-ready output, display-ready output, and/or audible output.

Software modules 128 and 148 include programmable instructions that are executable by processors 122 and 142, respectively, for performing the methods of the disclosure described herein. Merchant location server 120 is configured to provide a merchant location determination service when processor 122 executes the merchant location software module 128. Cardholder geolocation server 140 is configured to provide a cardholder geolocation determination service when processor 142 executes cardholder geolocation software module 148. Merchant location software module 128 and/or cardholder geolocation software module 148 can each be formed of multiple modules that can be stored separately on one or more storage devices and can be executed by one or more processing devices.

Merchant location server 120 and cardholder geolocation server 140 can be integrated, including integration of one or more components, such as processors 122 and 142, storage devices 124 and 144, communication devices 126 and 146, and user interface devices 127 and 147.

A method for providing a cardholder geolocation determination service, which can be implemented by the service provided by cardholder geolocation server 140, is disclosed in U.S. patent application Ser. No. 13/457,701, entitled, “Method for Providing Payment Card Security Using Registrationless Telecom Geolocation Capture,” filed on Apr. 27, 2012 (“the '701 patent application”), the entirety of which is incorporated herein by reference. The method includes the following example steps:

programming a computer to (1) search a first file in a database containing account information for a plurality of cardholder accounts, the account information for each cardholder account comprising a cardholder account number and transactions information, wherein the transactions information comprises transaction timestamps, merchant geolocations and card presence data for each transaction, (2) remove all cardholder accounts having fewer than ten transactions and create a plurality of filtered cardholder accounts and (3) compile a second file in the database from the first file containing account information for the plurality of filtered cardholder accounts;

programming the computer to randomly generate unique user identification numbers or hashes corresponding to each of the account numbers in the second file;

compiling a third file in the database from the second file, wherein the cardholder account numbers in the account information for the plurality of filtered cardholder accounts is replaced by the unique user identification numbers;

transmitting the unique user identification numbers and the transactions information for each of the corresponding filtered cardholder accounts to a mobile phone service provider, wherein the mobile phone service provider compares the transaction timestamps and merchant geolocations for each transaction in each filtered cardholder account with historic geolocation information for mobile phones operated by the mobile phone service provider and confirms to itself the identity of mobile phones owned by cardholders of the filtered cardholder accounts, wherein the mobile phone service provider compiles a list of confirmed unique user identification numbers;

receiving the list of confirmed unique user identification numbers from the mobile phone service provider;

compiling a security file in the database for the confirmed unique user identification numbers, wherein the security file contains information for each confirmed unique user identification number, the information comprising the cardholder account number and the confirmed unique user identification number;

programming the computer to identify payment authorization requests for the cardholder accounts in the security file, wherein each payment authorization request comprises transaction information;

sending a security query to the mobile phone service provider, the security query comprising the transaction information for the payment authorization request and the cardholder account's confirmed unique user identification number, the security query requesting a real-time geolocation of the mobile phone corresponding to the confirmed unique user identification number; and

receiving the real-time geolocation of the mobile phone from the mobile phone service provider in response to the security query.

Accordingly, cardholder geolocation server 140 can provide the geolocation of the cardholder's mobile phone 108 proximate to the time of a transaction, in real-time. Furthermore, the geolocation of the cardholder 104 may be provided at a different selected time, rather than in real time. The method for providing cardholder geolocation is performed in a secure manner such that only the mobile phone service provider knows confidential information associated with the cardholder's mobile phone 108, such as the phone number associated with the mobile phone 108 and the identification of the cardholder 104.

Additionally, the method for providing cardholder geolocation does not require that the cardholder 104 register for the service or be notified when it is used. On the other hand, the mobile phone service provider 154, payment network 101, merchant location server 120, and/or cardholder geolocation server 140 may opt to only provide the service upon receiving permission to do so from the cardholder 104 and/or providing notification to the cardholder 104 of its implementation, e.g., if necessary to comply with regulations.

The merchant location server 120 and cardholder geolocation server 140 can access a database system 152, e.g., for retrieving and/or storing data. Database system 152 can be integrated with one of the servers 120 or 140, or remote from one or both of the servers 120, 140.

Database system 152 may store, for example, the first, second, and third files and the security file, which may be accessed by the network system 101, merchant location server 120 and/or cardholder geolocation server 140 for storing or retrieving data.

One or more mobile phone service providers 154 provide service for operating mobile phones that are in their mobile phone network, e.g., enrolled in their service. The mobile phone service providers 154 include hardware and software for implementing the provision of service to mobile phones included in their mobile phone networks. The different mobile phone service providers 154 each operate with a different mobile phone network. A mobile phone 108 operated by a cardholder 104 is typically enrolled with one of the mobile phone service providers 154 and enabled to operate in its mobile phone network.

Each mobile phone service provider 154 includes a network of base stations that provide radio signals which a mobile phone included in the mobile phone network (herein referred to as an enrolled phone) uses for transmitting and receiving information. The base stations have limited range. A network of the base stations can provide coverage over a large area, such as a city, state, or country. As the mobile phone 108 travels, it may exit the area covered by a first base station and enter an area covered by a second base station. While a user is using the mobile phone 108 and traveling, the switch-over from using the first base station to the second base station is ideally transparent and seamless to the user. A mobile phone service provider 154 can store data that identifies the base stations that the mobile phone 108 used and the times of use. Using radiolocation, this data can be used to determine a location of the mobile phone 108 and/or track the location of the mobile phone 108. Additionally or alternatively, the mobile phone service provider 154 can determine and/or track the location of the mobile phone 108 by receiving or accessing GPS data provided by the GPS device included with the mobile phone 108.

Mobile service providers 154 record time-stamped location information at predetermined regular intervals, and or in response to an event, such as transmission of data to or from a mobile phone. The location information can be determined using radiolocation and/or GPS data. The location information is typically stored as geolocation data in the form of (latitude, longitude). Thus, the mobile phone service providers 154 have the capability to identify and record the geolocations of a cardholder's mobile phones 108 that is enrolled with their mobile phone network at or near the time the cardholder 104 makes a transaction at a merchant's POS device 102. There may be a time difference between the time of capture of a mobile phone's geolocation data and the time of the transaction, particularly when the capture of geolocation data is performed at regular intervals.

The POS devices 102, merchant location server 120, cardholder geolocation server 140, and mobile phone service providers 154 are in data communication with one or more networks 160. Network 160 can include, for example, hardware and software for implementing the Internet, an intranet, cellular communication, and wired telephone communication (e.g., using analog or digital plain old telephone lines (POTS)). Database system 152 can also be in data communication with network 160 and remote from servers 120 and/or 140. The data communication with network 160 can be wired or wireless.

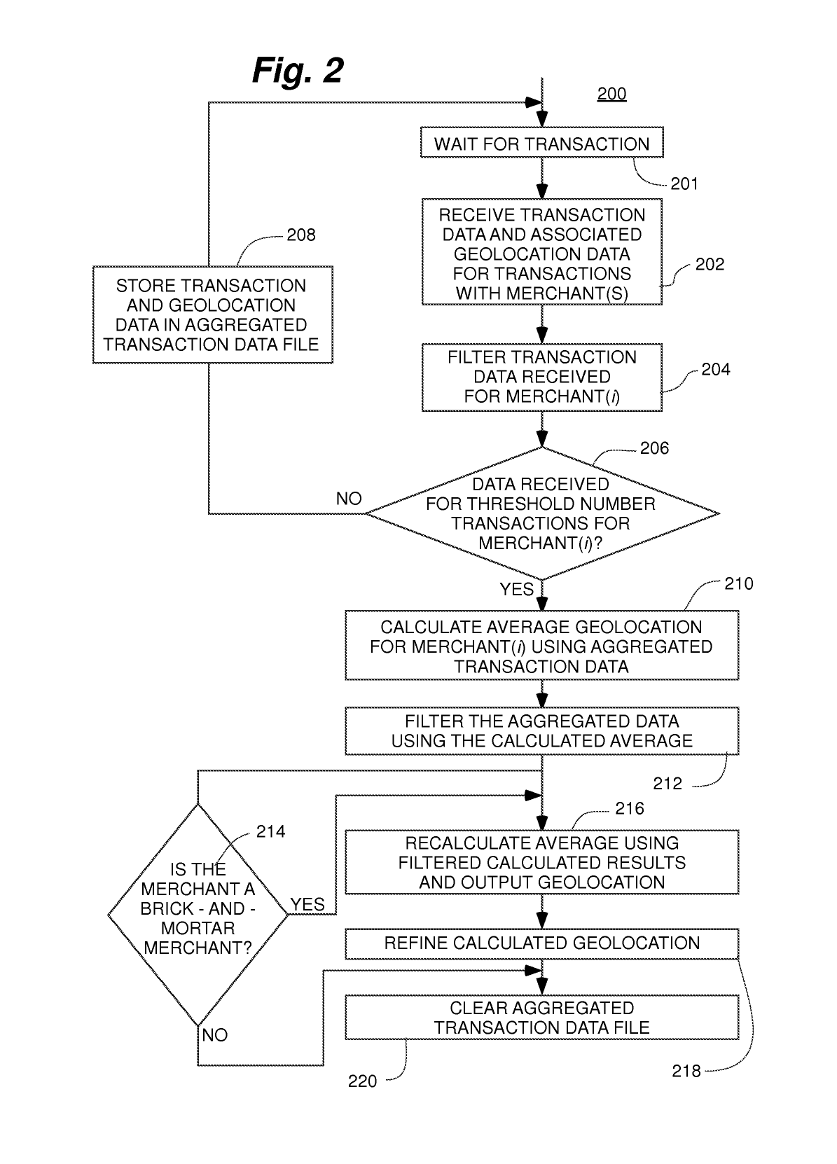

FIG. 2 includes a flowchart 200 that shows an example method for determining or correcting location data associated with a plurality of merchants 110.

At step 201, the merchant location server 120 waits for notification of the occurrence of a transaction. Upon receipt of such notification, processing advances to step 202. This example method illustrates processing transactions in real-time as the transactions occur, but the method of the disclosure is not limited thereto. The method may also be performed on transaction data that was received in the past, such as in a batch mode upon request or at regular time intervals, such as on a daily, weekly, or monthly basis.

At step 202, the merchant location server 120 receives transaction data related to a transaction between a cardholder 104 and a particular merchant 110(i) using a payment card 106, where i represents a unique identifier for the particular merchant 110. The transaction data is securely provided to the merchant location server 120 via the payment network 101.

Additionally, the merchant location server 120 receives location data associated with the transaction data that is indicative of a location of the cardholder making the associated transaction at the time of the transaction or a time proximate the transaction. For example, the location data may be user entered, e.g., by the cardholder or a clerk transacting the transaction on behalf of the merchant 100(i). The location data may be entered at the time of the transaction or at a time after the transaction. The location data may be entered in response to a query. The query may include a suggested merchant location provided by the merchant location server 120. The user response may indicate whether the suggested merchant location is incorrect or correct. Additionally, the user response may include a corrected location.

In one embodiment, the location data indicates a location, e.g., a geolocation, of the cardholder's mobile phone 108 at the time of the transaction. The geolocation of the cardholder's mobile phone 108 can be generated by the cardholder geolocation service provided by the cardholder geolocation server 140, e.g., by implementation of the method described in the '701 patent application. The mobile phone geolocation data may be provided in real-time, upon request, in response to an event, or at regular time intervals. The location data is referred to below as geolocation data, but is not limited to geolocation data and can be location data expressed as geolocation, street location, a location relative to a selectable reference point, etc. At step 204, the received transaction data is filtered by ignoring transactions in which the transaction indicates that (1) the transaction is a recurring payment transaction that was previously scheduled to occur and is a card-not-present transaction; and (2) the transaction data indicates that the transaction is a card-not-present transaction. This information is filtered out because it indicates that the POS device 102 is not located physically proximate to the payment card 106 and/or that the merchant 110 is not a brick-and-mortar merchant.

At determination step 206, a determination is made whether a threshold number of transactions have been performed between the merchant(i) and different payment entities (where the entities may be either cardholders 104 or payment cards 106). The threshold number is selected to achieve aggregation of transaction data so that the anonymity of cardholders 104, information related to their payment card 106 and mobile phone 108, and their geolocation is preserved. If the determination is “NO,” then processing continues at step 208. If the determination is “YES,” then processing continues at step 210.

At step 208, the transaction data and associated geolocation data received in the current iteration of flowchart 200 is stored in an aggregated transaction file 156 as aggregated transaction/geolocation data (herein referred to as aggregated data). In the current example, the cardholder geolocation data for each transaction includes latitude and longitude data, but is not limited thereto. Processing then returns to step 201 to wait for notification of a transaction.

At step 210, which is performed once sufficient aggregated data has been collected for merchant(i) in the aggregated transaction file 156, the aggregated data stored in the aggregated transaction file 156 is processed by calculating an average geolocation for the merchant(i). In one embodiment, the average geolocation of merchant(i) is determined as a straight average calculation, which includes summing latitude data and longitude for each transaction and dividing each sum by the number of transactions for which data is summed. Other methods for averaging location data are envisioned, such as averaging distances between locations indicated by the location data (e.g., location data other than geolocation data) from a fixed reference point.

In another embodiment, the average geolocation of merchant(i) is determined by performing a temporally-weighted average calculation. The geolocation data is weighted and then averaged, e.g., by multiplying each latitude or longitude value by its corresponding weight factor before summing. Geolocation data is weighted based on how proximate in time the time of capture of the geolocation data by the mobile service provider 154 is to the time of the transaction, with greater weights assigned for more temporally proximate geolocation data captures. Since mobile phone service providers 154 capture geolocation data at spaced time intervals, the closer the time of capture is to the time of the transaction, the more reliable the geolocation data is.

Equation (1) is an example equation for determining weight factors:

Weighting Factor=100%−ABS(Capture Time−Transaction Time)*10%, (1)

where:

Capture Time is the time that the mobile service provider captured the geolocation data; and

Transaction Time is the time of the transaction per the payment network 101 and/or per the transaction data.

In addition, when Capture Time−Transaction Time exceeds a predetermined threshold time, e.g., ten minutes, the geolocation data is not used, such as by setting the weight factor to zero or by skipping one or more processing steps. If this causes the number of transactions with merchant(i) to drop below the threshold number associated with regulatory aggregation requirements, then processing returns to step 201. Thus, the number threshold used at step 206 may be set higher than the regulatory requirement to allow for discarding data associated with some of the transactions. The averaged or weighted-averaged geolocation determined for merchant(i), which is output from step 210, is a preliminary merchant geolocation that can be further refined.

At step 212, the preliminary geolocation is used to filter the aggregated geolocation data. For example, for each transaction, the cardholder distance is determined, where the cardholder distance is the distance between the geolocation associated with the transaction and the preliminary merchant geolocation. In one embodiment, the cardholder distance is determined using the great circle distance, but is not limited thereto. For example, the cardholder distance may be determined as a travel distance, as the time needed to travel the distance, or a straight-line distance.

The filtering steps performed at step 212 can include one or more of the following, and is not limited to being performed in a particular order. These filtering steps are aimed at removing data that may be less reliable. One filtering step includes removing transactions from the aggregated data that have the largest values. This can be performed by selecting a threshold percentage, e.g., ten percent, and removing the transactions that have the largest threshold percentage of cardholder distances. Alternatively or additionally, a filtering step includes removing from the aggregated data transactions having associated cardholder distances that exceed a predetermined cardholder threshold. Again, the number threshold used at step 206 may be set higher than the regulatory requirement to compensate for discarded data associated transactions that are filtered out, so that after filtering is completed the requisite number of transactions are still aggregated.

At determination step 214, another filtering step is performed which includes determining whether the merchant(i) is a brick-and-mortar merchant. The determination at step 214 includes calculating an average of the cardholder distances determined in step 212. If the calculated average exceeds a predetermined cardholder distance threshold, then the determination is “NO,” the merchant(i) is an e-commerce merchant. Otherwise the determination is “YES,” the merchant is a brick-and-mortar merchant. Since the present method of using cardholder geolocations to determine the location of a merchant 110 is not effective when the merchant 110 is an e-commerce merchant, if the determination is “NO,” steps 216 and 218 are skipped, and processing resumes at step 220. If the determination is “YES,” processing continues at step 216.

At step 216, the average geolocation for merchant(i) is recalculated using the remaining aggregated transaction data, such as in accordance with a method described with respect to step 210. The data output from step 216 indicates the location of the merchant(i). The location is determined using aggregated, averaged geolocation data associated with multiple mobile phone users who are cardholders 104 that transacted transactions with merchant(i) using their payment cards 106. Thus, to preserve privacy and in accordance with privacy requirements that might exist, the geolocations of individual cardholders 104 are not output. Additionally, aggregation and averaging techniques have been used that preserve privacy. To promote integrity of the data, the data has been filtered to remove non-brick-and-mortar merchants and less reliable data.

At step 218, the average geolocation for merchant(i) that was determined at step 216 can be refined, such as by converting the geolocation to a street address, e.g., including using a reverse geocoder method that is known in the art. Alternatively or additionally, the average geolocation or street address for merchant(i) can be refined by using information that is available about the location of merchant(i), such as address information already stored by the payment network 101, and/or address information available from other sources, such as yellow pages, telephone directories, advertisements, etc.

At step 220, the data stored in the aggregated transaction data file for merchant(i) is cleared, which allows the process of verifying merchant(i)'s address to be repeated, such as with new transaction data when it is available, at a scheduled time, or in response to an event. An example of an event that may prompt a verification or correction of a merchant's address is discovery or suspicion of fraudulent activity.

Regular or continual performance of the method described for determining or correcting a merchant's location information is extremely valuable to a payment network 101 for detecting fraudulent activity. Having reliable information about the location of merchants within the payment network 101 increases the chance of detecting fraudulent activity without false alerts. For example, payment activity associated with a payment card can indicate that transactions have been made at brick-and-mortar merchants, but the locations of the merchants are suspicious. For example, two transactions may have been made proximally in time, but at physical locations that are too distant from each other for one person to have made both transactions. At this point, an alert can be generated, and the cardholder 104 can be queried as to whether the transactions are valid.

The method for determining the merchant location does not require that the cardholder 104 or merchant 110 register for the service or be notified when it is used. On the other hand, the mobile phone service provider 154, payment network 101, merchant location server 120, and/or cardholder geolocation server 140 may opt to only provide the service upon receiving permission to do so from the cardholder 104 and/or merchant 110 and/or providing notification to the cardholder 104 and/or merchant 110 of its implementation, e.g., if necessary to comply with regulations.

While the disclosure has been particularly shown and described with reference to specific embodiments, it should be apparent to those skilled in the art that the foregoing is illustrative only and not limiting, having been presented by way of example only. Various changes in form and detail may be made therein without departing from the spirit and scope of the disclosure. Therefore, numerous other embodiments are contemplated as falling within the scope of the present disclosure as defined by the accompanying claims and equivalents thereto.

It should be recognized that the components illustrated in FIG. 1 are exemplary only, and it is contemplated that the methods described herein may be implemented by various combinations of distributed hardware, software, firmware, circuitry, and/or processors and associated memory, for example, as well as other components known to those of ordinary skill in the art.

What is claimed is:

1. A computer implemented method for determining merchant locations, the method comprising:
receiving, by at least one processing device, transaction data and associated location data for transactions between at least one cardholder and at least one merchant, wherein the location data associated with each transaction is related to a location of a cardholder of the at least one cardholder making the associated transaction;
calculating, by the at least one processing device, an average location by averaging location data associated with a threshold amount of transactions for a merchant of the at least one merchant; and
determining, by the at least one processing device, a location of the merchant based on the calculated average location.

2. The method according to claim 1, wherein the location data associated with a transaction is related to a location of a mobile phone of a cardholder of the at least one cardholder making the associated transaction.

3. The method according to claim 2, wherein the location data is provided by a mobile phone service provider that provides service for operation of the cardholder's mobile phone.

4. The method according to claim 1, wherein the transaction data is processed in real time for determining when the threshold amount is received.

5. The method according to claim 1, further comprising filtering, by the at least one processing device, the location data using the calculated average location.

6. The method according to claim 5, further comprising recalculating, by the at least one processing device, the average location using the filtered location data.

7. The method according to claim 5, wherein the filtering includes determining a distance between the calculated average location and the location associated with respective transactions of the received transactions.

8. The method according to claim 7, wherein the filtering further includes filtering out received transactions that have an associated determined distance that exceeds a predetermined distance threshold.

9. The method according to claim 7, wherein the filtering further includes filtering out a predetermined percentage of the received transactions based on the magnitude of their associated determined distance relative to one another.

10. The method according to claim 7, wherein the filtering further includes determining a second average which is an average of the determined distances, and using the second average to make a determination about a characteristic of the merchant.

11. The method according to claim 10, wherein the filtering further includes discontinuing determining the location of the merchant when the second average exceeds a predetermined average threshold.

12. The method according to claim 2, wherein the calculating the average location includes assigning a weight to location data associated with the respective transactions based on a time difference between a time when the location data was captured and a time of the transaction.

13. A system for determining merchant locations, the system comprising:
a memory;
a computer device; and
a module stored in the memory, that when executed by the computer device, performs operations comprising:
receiving transaction data and associated location data for transactions between at least one cardholder and at least one merchant, wherein the location data associated with each transaction is related to a location of a cardholder of the at least one cardholder making the associated transaction;
calculating an average location by averaging location data associated with a threshold amount of transactions for a merchant of the at least one merchant; and
determining a location of the merchant based on the calculated average location.

14. The system according to claim 13, wherein the location data associated with a transaction is related to a location of a mobile phone of a cardholder of the at least one cardholder making the associated transaction.

15. The system according to claim 14, wherein the location data is provided by a mobile phone service provider that provides service for operation of the cardholder's mobile phone.

16. The system according to claim 13, further executable by the computer device for filtering the location data using the calculated average location.

17. The system according to claim 16, further executable by the computer device for recalculating the average location using the filtered location data.

18. The system according to claim 16, wherein the filtering includes determining a distance between the calculated average location and the location associated with respective transactions of the received transactions.

19. The system according to claim 18, wherein the filtering further includes filtering out at least one of: received transactions that have an associated determined distance that exceeds a predetermined distance threshold, and a predetermined percentage of the received transactions based on the magnitude of their associated determined distance relative to one another.

20. The system according to claim 18, wherein the filtering further includes determining a second average which as average of the determined distances, and using the second average to make a determination about a characteristic of the merchant.

21. The system according to claim 20, wherein the filtering further includes discontinuing determining the location of the merchant when the second average exceeds a predetermined average threshold.

22. The system according to claim 14, wherein the calculating the average location includes assigning a weight to location data associated with the respective transactions based on a time difference between a time when the location data was captured and a time of the transaction.
